(19) United States
(12) Patent Application Publication
(10) Pub. No.: US 2024/0070355 A1
(43) Pub. Date: Feb. 29, 2024

(54) THREE DIMENSIONAL ANALYSIS TECHNIQUES FOR CHARACTERIZING QUASI-STATIC PROCESSES

(71) Applicant: UNIVERSITY OF WYOMING, Laramie, WY (US)

(72) Inventors: Bradley MCCASKILL, Laramie, WY (US); Mohammad PIRI, Laramie, WY (US)

(21) Appl. No.: 18/239,220

(22) Filed: Aug. 29, 2023

Related U.S. Application Data
(60) Provisional application No. 63/402,004, filed on Aug. 29, 2022.

(51) Int. Cl. G06F 30/28; G06F 30/23

(52) U.S. Cl. CPC G06F 30/28; G06F 30/23; G06F 2113/08

(57) ABSTRACT

A method and system for pore network characterization by one or more processing units is disclosed. The method may include obtaining an input image of a porous media sample, extracting a representative pore network from the input image by storing a voxel image for one or more pore elements, based on the one or more pore elements, defining a threshold capillary pressure for each of a set of inlet elements of the one or more pore elements; invading the one or more pore elements with a fluid flow configuration, the fluid flow configuration based, as least in part, on the threshold capillary pressure.

### CROSS-REFERENCE TO RELATED APPLICATIONS

This applications claims benefit of U.S. Provisional Patent Application No. 63/402,004, filed Aug. 29, 2022, the entirety of which is herein incorporated by reference.

### BACKGROUND

### Field

Aspects of the present disclosure generally relate to characterizing of porous media, and more particularly, to pore network modelling.

### Description of the Related Art

Modeling techniques for fluid flow through porous media are broadly implemented for petroleum resource development, materials engineering, food packaging, and medical technology development. Fluid flow modeling techniques may be equipped to illustrate both physical and chemical media properties like permeability, capillary pressure, fluid saturation, contact angle, wettability, or other similar properties, which may be used to characterize fluid behavior.

Although current techniques for modelling fluid flow through porous media are based on technological advancements made over many years, resultant models may still be tenuous representations of actual porous media. For example, fluid flow models of porous media exceeding a few millimeters may require a lower resolution implementation to match currently available computational capabilities. As a result, fluid flow models based on porous media of a larger scale may not accurately reflect physical and chemical properties of the media. Accordingly, there is an impetus to improve the accuracy of fluid flow modeling, including, for example: improving image processing techniques to allow for higher resolution model input and model output, improving image processing techniques to allow for more accurate model input and model output, enhancing computational processing capability to reduce computational expense, enhancing computational processing capability increase modeling speed, increasing automation for iterative modeling steps, improving model capability for dynamic modeling of different fluid flow environments, improving model capability for dynamic modeling of larger fluid flow environments, and the like.

Consequently, there exists a need for further improvements in fluid flow modeling of porous media to overcome the aforementioned technical challenges and other challenges not mentioned.

### SUMMARY

One aspect of the present disclosure provides a method for pore network characterization by one or more processing units. The method may include obtaining an input image of a porous media sample, extracting a representative pore network from the input image by storing a voxel image for one or more pore elements, based on the one or more pore elements, defining a threshold capillary pressure for each of a set of inlet elements of the one or more pore elements, and invading the one or more pore elements with a fluid flow configuration, the fluid flow configuration based, as least in part, on the threshold capillary pressure.

One aspect of the present disclosure provides a method for pore network characterization by one or more processing units. The method may include obtaining a voxel image representing a porous media sample, the voxel image having one or more pore elements representing the porous media sample, identifying one or more surfaces for each of one or more pore elements, defining one or more spheres along the one or more surfaces, generating voxel interfaces based, at least in part, on a set of locations where some of the one or more pore elements contain a portion of the one or more spheres, and refining the voxel interfaces to produce a fluid flow configuration capable of invading the one or more pore elements.

One aspect of the present disclosure provides an apparatus for porous media characterization comprising a memory and one or more CPU, the one or more CPUs configured to cause the apparatus to perform a method. The method may include obtaining an input image of a porous media sample, extracting a representative pore network from the input image by storing a voxel image for one or more pore elements, based on the one or more pore elements, defining a threshold capillary pressure for each of a set of inlet elements of the one or more pore elements, and invading the one or more pore elements with a fluid flow configuration, the fluid flow configuration based, as least in part, on the threshold capillary pressure.

One aspect of the present disclosure provides an apparatus for porous media characterization comprising a memory and one or more CPU, the one or more CPUs configured to cause the apparatus to perform a method. The method may include obtaining a voxel image representing a porous media sample, the voxel image having one or more pore elements representing the porous media sample, identifying one or more surfaces for each of one or more pore elements, defining one or more spheres along the one or more surfaces, generating voxel interfaces based, at least in part, on a set of locations where some of the one or more pore elements contain a portion of the one or more spheres, and refining the voxel interfaces to produce a fluid flow configuration capable of invading the one or more pore elements.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only example aspects and are therefore not to be considered limiting of its scope, may admit to other equally effective aspects.

FIG. 1A depicts an example pore network model extracted from a porous media sample made of sandstone.

FIG. 1B depicts an example set of high-resolution porous media image taken by a scanning instrument from a single rock sample and segmented for characterization.

FIG. 2 depicts an example core-flooding instrument for determining the physical and chemical characteristics of a porous media sample.

FIG. 3 depicts an example fluid flow modelling procedure for characterizing of porous media by one or more processors, according to aspects of the present disclosure.

FIG. 4 depicts an example free body diagram of the interfacial tensions between two fluid phases in contact with a solid phase, according to aspects of the present disclosure.

FIG. 5 depicts different views of an example pore network element, generated according to aspects of the present disclosure.

FIG. 6 illustrates an example relation between a Euclidean point and a defined sphere center.

FIG. 7 illustrates an example discretization of a spherical surface, generated according to aspects of the present disclosure.

FIG. 8 illustrates example interfaces formed by a set of defined spheres, generated according to aspects of the present disclosure.

FIG. 9 illustrates example centers of the spheres defined for a cubical surface at different stages of a selection process, generated according to aspects of the present disclosure.

FIG. 10 illustrates example interfaces that are converging towards and diverging from the wetting region, generated according to aspects of the present disclosure.

FIG. 11 illustrates example interfaces that intersect with a surface with different contact angles, generated according to aspects of the present disclosure.

FIG. 12 depicts example results from a validation study addressing aspects of the present disclosure.

FIG. 13 depicts and an example solution of a validation study addressing aspects of the present disclosure.

FIG. 14 depicts example optimal fluid configurations obtained when different contact angles are considered, according to aspects of the present disclosure.

FIG. 15 is a flow diagram illustrating certain operations by one or more processors, according to certain aspects of the present disclosure.

FIG. 16 is a flow diagram illustrating certain operations by one or more processors, according to certain aspects of the present disclosure.

FIG. 17 is an example device for characterizing porous media.

FIG. 18 is an example device for characterizing porous media.

To facilitate understanding, identical reference numerals have been used, where possible, to designate identical elements that are common to the figures. It is contemplated that elements and features of one aspect may be beneficially incorporated in other aspects without further recitation.

### DETAILED DESCRIPTION

In the following, reference is made to aspects of the disclosure. However, it should be understood that the disclosure is not limited to specifically aspects described. Instead, any combination of the following features and elements, whether related to different aspects or not, is contemplated to implement and practice the disclosure. Furthermore, although aspects of the disclosure may achieve advantages over other possible solutions and/or over the prior art, whether or not a particular advantage is achieved by a given aspect is not limiting of the disclosure. Thus, the following aspects, features, aspects, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim(s).

The present disclosure relates to techniques for physical characterization of porous media. Specifically, the techniques discussed herein may be implemented for non-destructive extraction of geometric information, capillary pressure and wettability information from porous media samples. The porous media sample may comprise a digital rock sample, a rock sample, a core sample, a plastic sample, a tissue sample, a rough-walled fracture space, or any other organic or inorganic sample having pore space ascertainable through imaging techniques.

A thorough grasp of fluid flow through porous spaces of certain materials may be consequential to enhancing technical efficacy of fluid flow techniques in a wide range of industries. Models of fluid flow are useful to describe physical and chemical characteristics of a porous material and may help to highlight the material's optimal usage. Often, networks of pores within a material are extremely small (e.g., microscale in size). Techniques for characterizing these pore networks are hindered by the computational expense of modeling at a microscale. To alleviate computational burdens, pore network modelling techniques often implement generalized characterization techniques at expense of model accuracy. Extrapolation errors caused by such imprecise characterization may result in mischaracterization of physical and chemical characteristics of the porous material. In many cases, these errors render such models impractical for regular use. Accordingly, ideal modeling of fluid flow through porous media would allow for rapid, accurate characterization of microscale pore spaces that may be performed without inhibitive computational expense.

Aspects of the present disclosure provide techniques for generating heterogeneous digital representations of porous media (e.g., heterogeneous plugs) that replicate the key physical properties of heterogeneous porous media samples. Specifically, one or more processors may be configured to replicate and merge sub-networks that represent distinct physical formations (e.g., layering, facies, sub-structures) within of the sample to mimic the structure of the porous media sample. Additionally, the one or more processors may generate these heterogeneous plugs based on porous media samples, which may be used to predict physical properties of large-scale bodies from which the porous media sample is derived when physical samples of the large scale bodies are unavailable.

Aspects of the present disclosure provide techniques for pore network duplication, stitching, and stochastic blending. Specifically, one or more processors may be configured to generate heterogeneous digital representations of porous media that reflect the local topology and heterogeneity of the entire sample. Additionally, aspects of the present disclosure may be parallelized to optimize computational performance.

Implementation of techniques for efficiently generating high-resolution pore networks as described herein may enhance pore network modelling functionality by reducing porous material characterization errors to the benefit of all users seeking a more comprehensive understanding of any given porous material.

### Introduction to Pore Network Modeling

Modeling techniques for fluid flow through porous media may illustrate both physical and chemical porous media properties. Models of porous media may be used to ascertain permeability, capillary pressure, fluid saturation, wettability, buoyancy, and the like to a greater degree of accuracy more comparable to physical flooding of a porous media sample. Additionally, physical and chemical properties determined using pore network modeling techniques may be used to characterize in-situ fluid behavior as it travels through the porous media under a wide variety of wettability and flooding conditions. These conditions are not typically accessible to users performing conventional physical flooding characterization techniques.

Permeability is the tendency of the porous media to allow liquids to flow through the porous media. Capillary pressure is the pressure difference existing across the interface separating two immiscible fluids. Fluid saturation is the measurement of fluid present in the pore spaces of the porous media. Contact angle is a measured angle between a fluid-fluid or a fluid-gas interface at a point where it meets a solid surface. Wettability is the ability of a liquid to maintain contact with a solid surface. Wettability may vary depending on wettability conditions and the type of wetting liquid present in the porous media sample. For example, a water-wet medium may show a lower wetting affinity to the oil phase than an oil-wet medium, where higher or lower wetting is determined with respect to a given phase. In certain cases, the correlation between wettability and viscosity ratio may not be straightforward, as there may be water or oil wet conditions with similar viscosities.

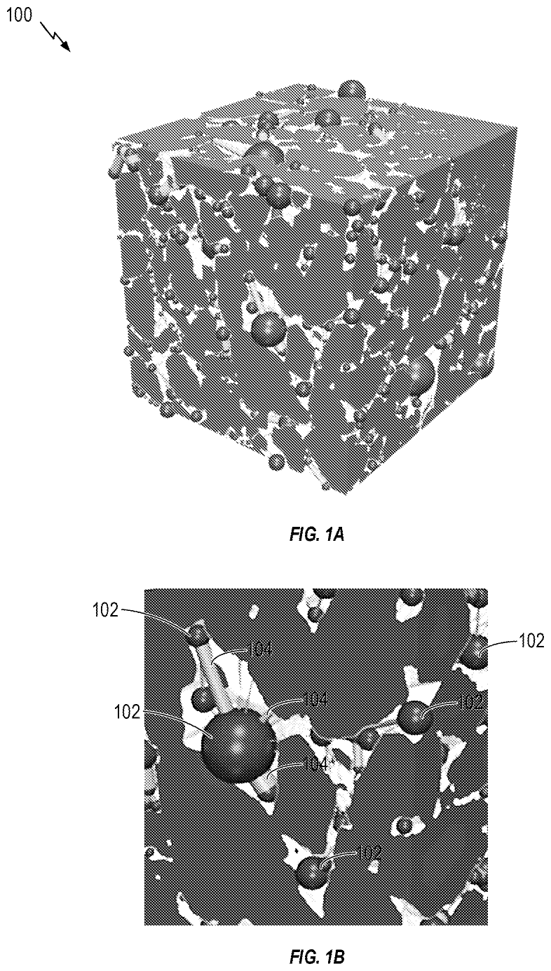

A modeled pore network is a practical description of a porous medium targeted for fluid flow modeling. FIG. 1A illustrates an example section of a pore network extracted from porous sandstone. The section of the pore network describes the porosities of various size and shape present in that portion of the sandstone, and may be used to model fluid flow through those porosities for various wettability conditions. Three-dimensional (3D) portions of a pore network model may more accurately characterize the porous media sample either alone or in combination with other 3D portions of the pore network model.

Pore network models (e.g., of FIG. 1A) may be extracted from images of a targeted porous medium and used to model fluid flow using certain displacement mechanisms across pores defined in a pore network. Displacements may represent an estimated positional change of a modeled fluid in response to movement of another fluid or gas within the pore network. As immiscible phases react with one another throughout the pore network during fluid flooding, displacements are induced where, for example, capillary pressure across a meniscus exceeds the wettability constraints on either phase. Fluid saturation, contact angle, buoyancy, and the like may also affect displacements throughout a pore network. By utilizing a pore network model extracted from a porous media sample, a user is able to ascertain displacement characteristics through the porous media sample under a wide variety of wettability conditions in order to ultimately obtain useful internal flow structure information for a larger sample of the porous medium without degrading a porous media sample via repeated physical flooding.

To properly generate displacements at a pore scale for the targeted porous media, imaging may capture complex geometries of the targeted porous media at a resolution sufficiently high to retain acceptable accuracy. An example of these geometries is illustrated in FIG. 1B. Pores may be defined as a complex polyhedron having at least a center 102 and spherical and effective diameters. Connective throats 104 between pores may also be defined. In many cases, image resolution may be in micrometers to capture applicable pore detail. High-resolution pore models enable accurate rendering of the fluid flow characteristics described above as ascertained at each pore and for each displacement.

Displacements may occur upon flooding or draining of a pore network model, where aqueous phase injection or removal is iteratively simulated through the pore network. Aqueous flooding and aqueous draining may be implemented in various modeled wettability conditions, where certain fluids are present prior to the start of a simulation. Wettability conditions may include at least water-wet, oil-wet, or mixed-wet conditions. During aqueous flooding, injected water may displace immiscible fluid preexisting in the pore network model. During aqueous draining, injected immiscible fluid may displace water preexisting in the pore network model. In certain cases, flooding and draining may be fluid flooding and fluid draining. In some cases, the fluid is oil.

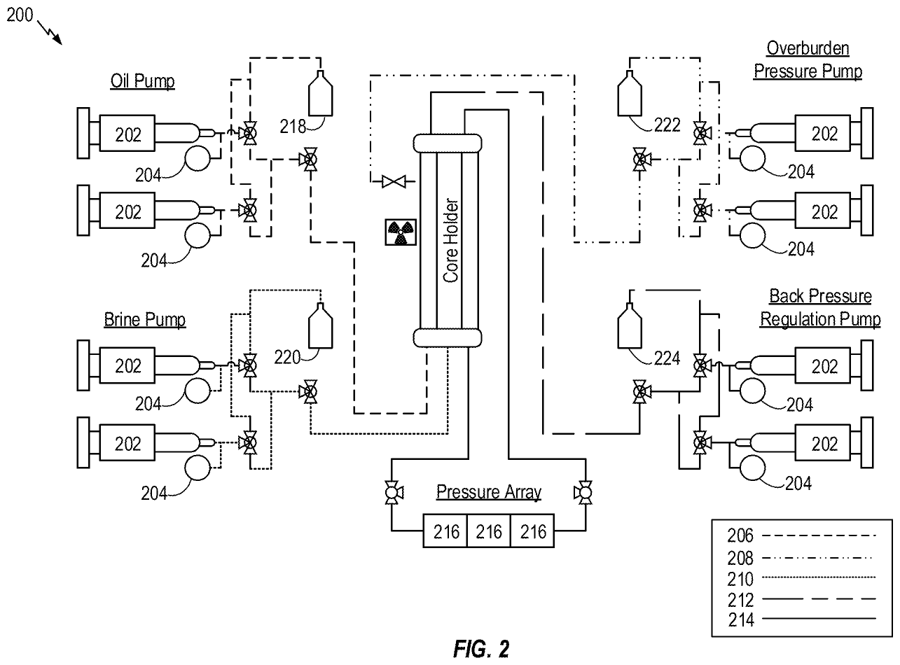

Flooding or draining of a pore network model may be simulated based in part on scanned images of physical flooding implemented by a flooding instrument 200 of FIG. 2. In some cases, a porous media may undergo a core-flooding experiment to establish an irreducible water saturation, a residual oil saturation, or both. Core-flooding is enabled by a set of pumps 202, rupture disks 204, pump lines 206-214, differential pressure transducers 216, and source buckets 218-222 working in tandem to flood a porous media sample loaded in a core holder. In some cases, a scanning instrument (e.g., a micro computed tomography (micro-CT) scanner) captures a dry reference image prior to flooding. Scanning occurs in a field of view defined within the core holder. The porous media sample may be flooded with brine from bucket 220 via the brine tubing line 206 and scanned again to ensure that the porous media sample is fully saturated. Once the brine flooding is complete, the absolute permeability of the porous media sample may be obtained. The oil flooding may be performed alongside additional brine flooding. Any fluid expelled as a result of overburden pressure (i.e., pressure that compacts pore space and reduces permeability) is transported via the confining fluid line 208 and collected in bucket 222. Any fluid expelled as a result of the flooding procedure is transported via the effluent fluid line 212 and collected in bucket 224. In many cases, core sample pressure may be iteratively adjusted during flooding. Pressure may be recorded by one or more differential pressure transducers 216 coupled to the core holder via a transducer line 214.

Scanned images obtained from flooding procedures performed by the flooding instrument 200 of FIG. 2 may be used to extract a pore map representative of the porous media sample prior to, during, or after flooding. The images may be processed to determine characteristics of fluid flow through the porous media sample. In many cases, the images may also be used to extract a representative pore network model. Pore network extraction may extract pore networks from an image of a porous media sample that are in one-to-one correspondence with the porous media sample within a reasonable computational time. Extraction may also allow for partitioning of void space into pore bodies and pore throat elements as primarily determined by the local geometry of the pore space. In some cases, the pore bodies and pore throat elements may be deconstructed and arranged to highlight optimal fluid flow paths.

Imaging of porous media is typically performed using micro-CT imaging. In many cases, commercial micro-CT scanners (e.g., Zeiss scanners) are available for imaging necessary to perform pore network modelling. Images of porous media taken by micro-CT scanners are at a sufficiently high resolution to create a microscale digital image of the porous media.

In the current state of the art, there exists a challenge of extracting porous media characteristics in a manner precise and repeatable to ensure the ultimate stability of future simulations. Currently, techniques for porous media characterization require lengthy step-wise processing known to incur undue computational expense and introduce instability to characterization of the porous media sample. As a result, users may not be able to rely on characterization output to simulate flow conditions in a useful way.

### Example Capillary Pressure and Fluid Interfacing

There are two foundational relationships of fluid flow that may be relevant to aspects of the present disclosure. First, the connection of capillary pressure to fluid tension plays a central role in defining appropriate fluid interfaces within a given pore space. Second, a thermodynamic description of fluid displacement mechanics is useful to determine optimal fluid configurations after displacement.

The configuration of fluid and solid phases that are in contact with each other may be locally controlled by energy balance. In order for free energy in a fluid flow system to be minimized, the work done against the pressure difference of the two fluids may equal the change in interfacial energy. For wetting (w) and nonwetting (nw) fluids in contact with each other this relation can symbolically be written as:

(P_{nw}−P_{w})dV=σdA (1)

where a is the interfacial tension between the two phases. dV represents an infinitesimal change in volume, and dA represents an infinitesimal change in surface area. P_{w} represents the fluid pressure of phase w. To maintain consistency, the change in volume dV may be positive for increases in volume of the nonwetting phase relative to the wetting phase. By defining the local capillary pressure, P_{c}, to be the difference between the nonwetting and wetting fluid pressures and rearranging (1), it follows that:

$${P}_{c} = σ \frac{dA}{dV} \qquad ( 2 )$$

By rewriting dV and dA in terms of r₁ and r₂, the principle radii of curvature at a point on the interface, respectively, and simplifying (2) the following equation may be obtained:

$${P}_{c} = σ \frac{1}{{r}_{1}} + {\frac{1}{{r}_{2}}}_{ } = σκ \qquad ( 3 )$$

The constant, κ, is proportional to the mean curvature of the interface.

At equilibrium, the capillary pressure may be a fixed constant. The mean curvature of the interface may also be fixed. Consequently, although the values of r₁ and r₂ at different points along the interface may change, they are constrained by the relation:

$$\frac{1}{{r}_{1}} + \frac{1}{{r}_{2}} = {\frac{{P}_{c}}{σ}}_{ } . \qquad ( 4 )$$

To simplify the development of aspects described herein, it may be assumed that the threshold capillary pressure is constant in a given network element. It then follows that the fluid interfaces that form within the pore space may have a constant mean curvature. This may reduce the number of possible geometric objects that can define the fluid interfaces, resulting in decreased computational expense. Notably, the only surfaces of revolution with constant mean curvature are the plane, cylinder, sphere, catenoid, undoloid, and nodoid. Moreover, for a surface to define a valid interface within the pore space, it may intersect the boundary at a fixed contact angle.

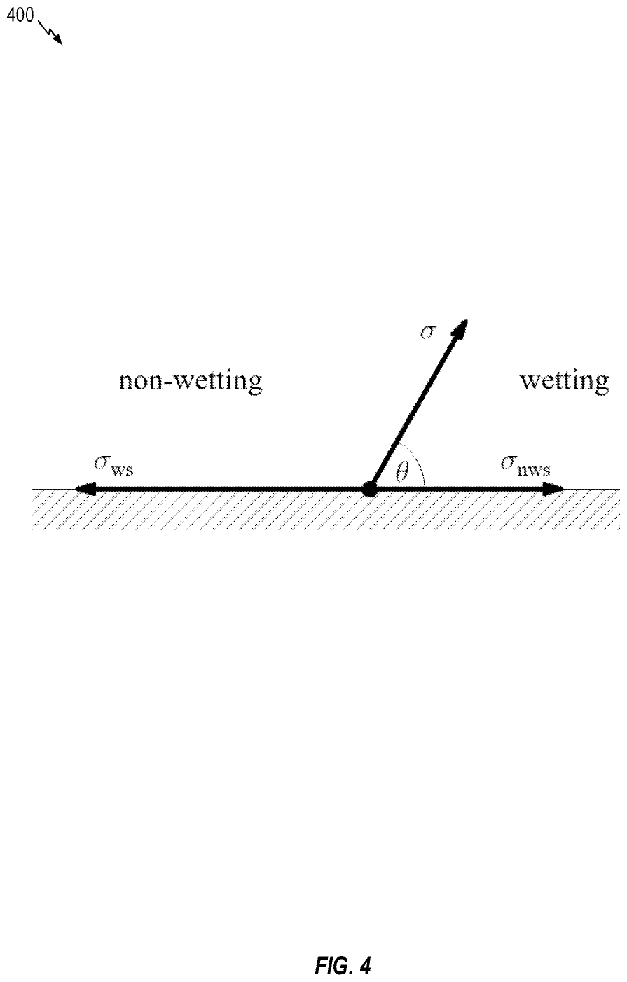

FIG. 4 illustrates a free body diagram of the interfacial tensions between two fluid phases in contact with a solid phase By balancing the interfacial tensions depicted in FIG. 4, the following equation may be obtained:

σ_{nws}=σ_{ws}+σ cos(θ) (5)

In this equation, σ_{ws} represents the interfacial tension between phase w and the solid phase, and σ_{nws} represents the interfacial tension between phase nw and the solid phase, where θ is the contact angle of the two fluids.

Where pore geometry and contact angle are ascertainable, the fluid configurations within the pore network may be determined by balancing free energy of the system. In some cases, the change in free energy associated with infinitesimal fluid movements may be minimized.

Let A represent the area of the interface between two fluids and Aws be the area between fluid phase w and the solid phase. Then the change in free energy of the system is given by the following:

dF=σdA+σ_{ws}dA_{ws}+σ_{nws}dA_{nws}+(P_{w}−P_{nw})dV (6)

In this way, the free energy of the system may be described as a balance of the fluid pressures weighted against the change in fluid volume, and the surface tension weighted against changes in the surface area of the fluid configurations. Notably, for a given perturbation, if dF<=0 then it is considered a favorable change, and the system is in equilibrium when dF=0. Since one or more processors may consider the presence of two distinct fluid phases, it is noted that if the volume of one phase is increased, the volume of the other phase must correspondingly decrease.

If the interfacial tension between the fluids, a, and the mean curvature of the fluid interface are ascertainable, then capillary pressure may be calculated. For simple geometries, capillary pressure may be directly estimated. However, in the current state of the art, it is generally difficult to perform these estimations directly. According to aspects of the present disclosure, techniques described herein may facilitate optimal fluid configuration modelling within a pore network element that may allow for more direct estimation of pore network characteristics.

### Aspects Related to Pore Network Modeling

Fluid flow modelling through porous media is often utilized to enhance petroleum resource development. In recent years, global demand for energy resources has mobilized development of unconventional petroleum reservoirs as targets for hydrocarbon extraction. The geological formations that comprise these newly developed hydrocarbon reservoirs are ultra-tight shale formations resistant to primary petroleum extraction techniques. A matrix of an ultra-tight unconventional shale reservoir may be characterized by low permeability and low porosity. To extract hydrocarbons from the ultra-tight shale matrix, secondary and tertiary petroleum extraction techniques seek to maximize oil production through the microscale pore networks that comprise a substantial amount of the porosity in the shale matrix.

A robust understanding of fluid flow through microscale pore networks of hydrocarbon reservoirs may be consequential to extracting the trillions of barrels of oil and gas still housed in shale formations globally. Models of fluid flow through a pore network that incorporates permeability, capillary pressure, fluid saturation, contact angle, wettability may help to elucidate specific steps to be taken during resource development to optimize petroleum production. Even so, techniques for characterizing these microscale pore networks are hindered by the computational expense of modeling microscale pore network and extrapolation errors caused by oversimplified characterization of pore geometries.

As discussed above, ideal modeling of fluid flow through porous media would allow for precise, quick, and repeatable characterization of a porous media sample. In a case where the porous media sample is, for example, a cylindrical core sample of a rock having a length of six inches and a diameter of one inch, the core sample is likely to have porosity and permeability characteristics that vary across its length and width. This is common in core samples and especially in core samples representative of ultra-tight oil formations. Geological processes that form certain oil-bearing rocks can produce heterogeneous morphological features in the rock that may be present even at a micrometer scale. This is especially true for oil-bearing carbonate rocks, which contain micro-porosities that contribute significantly to the overall porosity of the rock. These microscale morphological features may affect the pore network of the core sample, altering the porosity and permeability throughout a core sample. Thus, accurate characterization of fluid flow through a core sample may depend on precisely ascertained and verifiable microscale geometries sufficient to detect heterogeneous properties of a pore network. Using conventional estimation techniques that cannot consistently capture the heterogeneity and complexity of either the core sample or the fluid-fluid interfaces present therein may result in characterization of a porous media sample that cannot be used to consistently describe fluid flow through the core sample.

According to aspects of the present disclosure, the pore network extraction procedure described herein may be performed by a processing system architecture comprising at least one or more central processing units (CPUs) operating independently or in combination with one or more graphics processing units (GPUs). Techniques for pore network construction performed by processors operating in sequence may be unable to support the computational load associated with microscale pore networks. Techniques implemented herein may address issues with resolution sufficiency and issues arising from the computational expense of high-resolution pore network extraction. The one or more CPUs and/or the one or more GPUs may perform the procedures according to a non-transitory computer readable medium that causes the one or more CPUs and/or the one or more GPUs to perform any and all steps of the procedure. Each of the one or more CPUs may be utilized in combination with a memory having the computer readable medium stored thereon. Each of the one or more CPUs be utilized in combination with one or more processors. Each of the one or more processors may be parallel processors. Each of the one or more GPUs may be utilized in combination with a memory having the computer readable medium stored thereon. Each of the one or more GPUs be utilized in combination with one or more processors. Each of the one or more processors may be parallel processors. Each of the CPUs and the GPUs may operate independently, or may operate using a message passing interface (MPI) enabling communication between one or more parallel processors for performing the procedure. This may include CPU-CPU communication, CPU-GPU communication, and/or GPU-GPU communication.

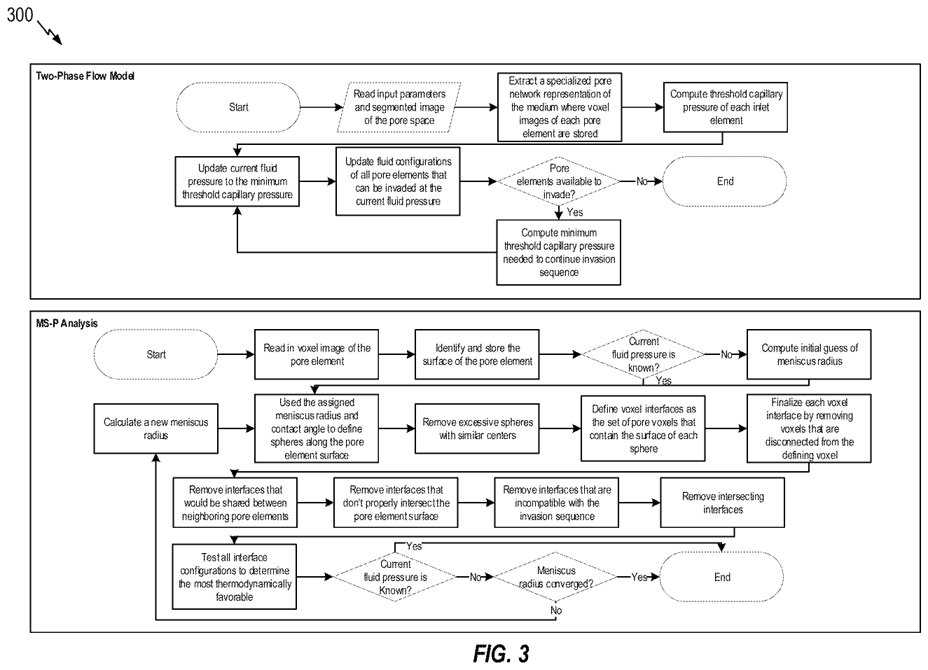

Aspects of the current disclosure provide a two-phase flow model step an and a characteristic analysis step, as illustrated in the example work flow provided in FIG. 3. The two steps may comprise a semi-direct pore network model (SD-PNM), which is a PNM in which the geometry of the pore space has not been simplified. Instead of simplification, each pore and throat of the pore network represents a collection of voxels. During the construction of this voxel-based model, processors may directly perform thermodynamic analysis on the voxel image of the network element (e.g., a pore element or a throat element) to determine optimal fluid configurations within the pore network and to estimate the threshold capillary pressures across the pore network.

As illustrated in FIG. 3, after the start of the two-phase flow model step, one or more processors (e.g., CPUs) read in input parameters and at least one segmented image of a target pore space. The processors extract a specialized pore network representation of the porous medium where voxel images of each pore are stored. The processors then compute a threshold capillary pressure of each inlet element, and update current fluid pressure to the minimum threshold capillary pressure. The processors update fluid configurations of all pore elements that can be invaded at the current fluid pressure. The processors then evaluate whether there are pore elements available to invade. If there are pore elements to invade, the processors compute minimum threshold capillary pressure that may be needed to continue an invasion sequence, and again update the current fluid pressure to the minimum threshold capillary pressure. If there are not pore elements to invade, the two phase flow model step is ended.

The one or more processors may then proceed to a characteristic analysis step (e.g., a Mayer, Stowe and Princen (MS-P) step). As illustrated in FIG. 3, after the start of the analysis step, the processors read in a voxel image of a pore element and identify and store the surface of the pore element. The processors then evaluate whether a current fluid pressure is known or ascertainable. If the current fluid pressure is known or ascertainable, the processors proceed to using an assigned meniscus radius and contact angle to define spheres along the pore element surface. If the current fluid pressure is not known or ascertainable, the processors compute an initial estimation of the meniscus radius, then proceed to using an assigned meniscus radius and contact angle to define spheres along the pore element surface. Next, the processors remove excessive spheres with similar centers and define voxel interfaces as the set of pore voxels that contain the surface of each sphere. The processors then finalize each voxel interface by removing voxels that are disconnected from the defining voxel. The processors remove interfaces that would be shared between neighboring pore elements, remove interfaces that do not properly intersect the pore element surface, remove interfaces that are incompatible with the invasion sequence, and remove intersecting interfaces. The processors then test all interface configurations to determine the most thermodynamically favorable. The processors again evaluate whether a current fluid pressure is known or ascertainable. If the current fluid pressure is known or ascertainable, the processors end the procedure and output results. If the current fluid pressure is not known or ascertainable, the processors evaluate whether a meniscus radius is converged. If the meniscus radius is not converged, the processors calculate a new meniscus radius, and again use an assigned meniscus radius and contact angle to define spheres along the pore element surface. If the meniscus radius is converged, the processors end the procedure and output results.

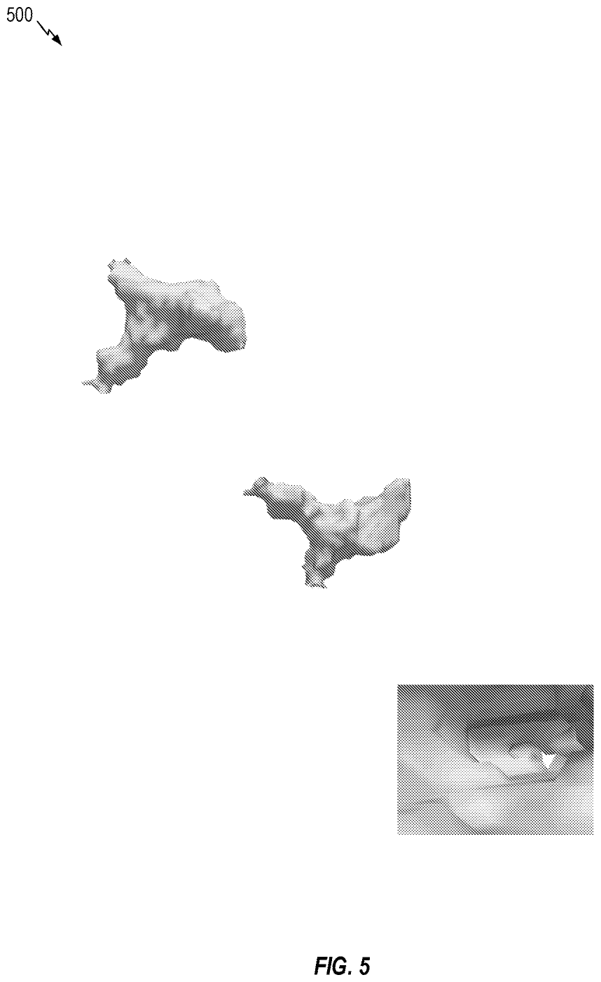

According to certain aspects, one or more processors (e.g., CPUs) may represent fluid interfaces within a pore space as the surfaces of spheres. The processors may define the spheres using the constraint that they intersect with the surface of the pore space at a known contact angle of the fluid interface. The processors filter the constructed set of candidate interfaces through a set of selection criteria, then perform an analysis step on these interfaces to determine the optimal fluid configurations within the pore space. Different views of a pore element having a pore space are illustrated in FIG. 5. Exterior views of the same region are shown on the left and in the middle, and a view from inside the pore space is provided on the right.

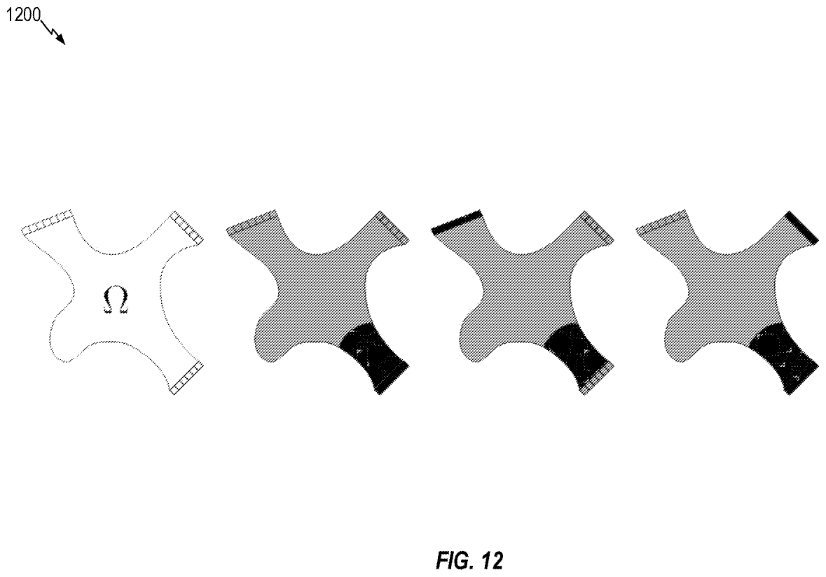

The one or more processors may let a value, Ω, represent the collection of voxels (an example may be found in FIG. 12). The collection of voxel may have uniform width, h, that define a network element. The processor may define the surface of Ω to be the set of voxel faces that are shared by elements of Ω and additional voxels corresponding to solid phase. To construct a solid phase set, Γ, the processors check each ω∈Ω to see if one of its neighboring voxels is part of the solid phase. In other words, each voxel of the pore space is checked to see if it neighbors a solid phase voxel. If it does, then the face, ω, shared between this voxel and the solid face is added to Ω. That is, each element Ω is a square that lies between a voxel of the solid phase and the pore body. This check is performed using a stencil with six components (neighboring voxels that share a face with ω). If any of the voxels sharing a face with ω is from the solid phase, then their shared face is added to the set Γ. The threshold capillary pressure of each network element may be estimated using an iterative procedure by the one or more processors. After an initial estimation for the meniscus radius has been provided, each iteration is performed to obtain a more accurate estimate of its value.

When the interface of two fluids touches a solid, it may conform to the wettability of the solid surface. Under equilibrium conditions, this fluid-fluid interface meets the solid surface at a constant contact angle. The one or more processors may use this constraint to define a set of spheres along the surface of the network element if the radius of the meniscus, r, is known or ascertainable. In this portion of the analysis, candidate fluid interfaces may be defined from spheres with radius r that intersect with the surface at the angle θ.

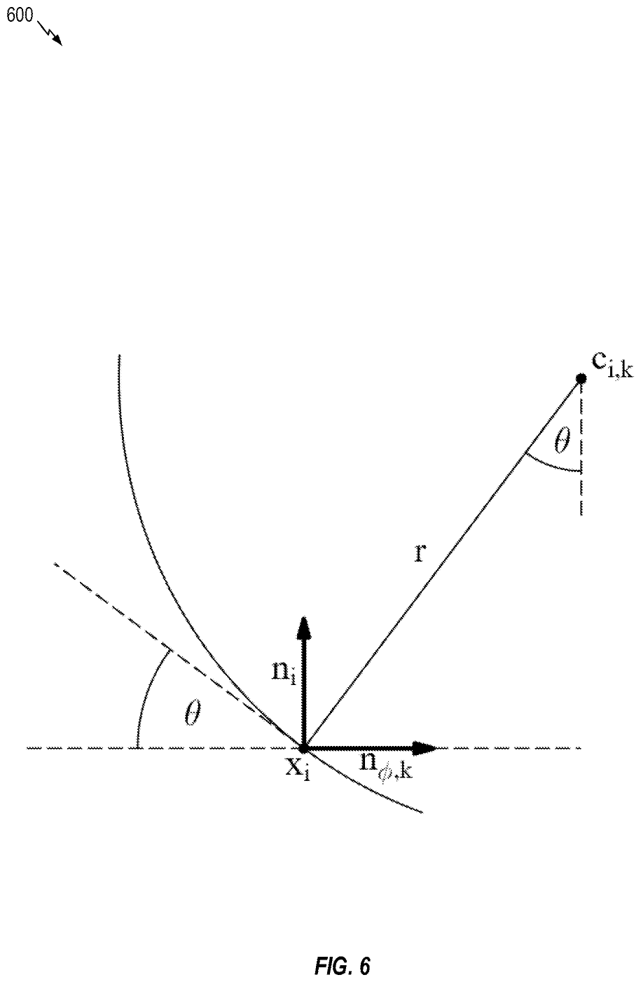

For a given face γᵢ ∈Γ, the one or more processors may define nᵢ as the unit normal vector to γᵢ that points away from the solid phase. Additionally, the processors may let the Euclidean point xᵢ=(xᵢ,yᵢ,zᵢ) be the center of symmetry of γᵢ. An illustration between the relation between this point and the defined sphere center is provided in FIG. 6. The processors may define spheres such that the circular cross section that contains the spheres center and the point xᵢ intersect γᵢ at xᵢ with angle θ. To this end, the processors may discretize the radian interval [0, 2π) into N_{α} segments of uniform length α. The value of N_{α} may be a variable value selected to optimize the computational resources that are available. The processors may then map the angular discretization to the plane on which γᵢ lies (e.g., the plane perpendicular to nᵢ that contains xᵢ). For k=0, 1, . . . , N_{α}, the processors may let n_{φ,k} be the unit vector that is perpendicular to nᵢ and has an angle ϕₖ=αₖ in the plane that contains γᵢ. For k=0, 1, . . . , N_{α} the one or more processors may let s_{i,k} ∈S²(r, xᵢ) represent a sphere with radius r and center, c_{i,k}, which may defined as follows:

c_{i,k}=xᵢ+r cos θnᵢ+r sin θn_{φ,k} (7)

If the orientation of the voxel image is in agreement a Cartesian coordinate system, the construction of the unit vectors nᵢ and n_{i,k} is a straightforward process. In this case, the face γᵢ may be perpendicular to one of the coordinate vectors eₓ, e_{y}, or e_{z}. Consequently, once the correct coordinate vector is identified, only the sign of nᵢ may be determined. In one example, if nᵢ=e_{z}, the angular partition of [0, 2π) may be placed in a standard position in the xy-plane. The unit vectors that are perpendicular to nᵢ can directly be defined as n_{φ,k}=(cos φₖ, sin φₖ, 0). A similar procedure may be used to determine n_{φ,k} if nᵢ is eₓ or e_{y}.

According to certain aspects, a set of spheres may be defined by the one or more processors for each γᵢ ∈Γ. Specifically, Ψ may be used denote the total set of spheres defined in this manner, and may be defined according to the following:

Ψ={s_{i,k}∈S²(r,xᵢ)|k=0,1, . . . N_{α},γᵢ∈Γ} (8)

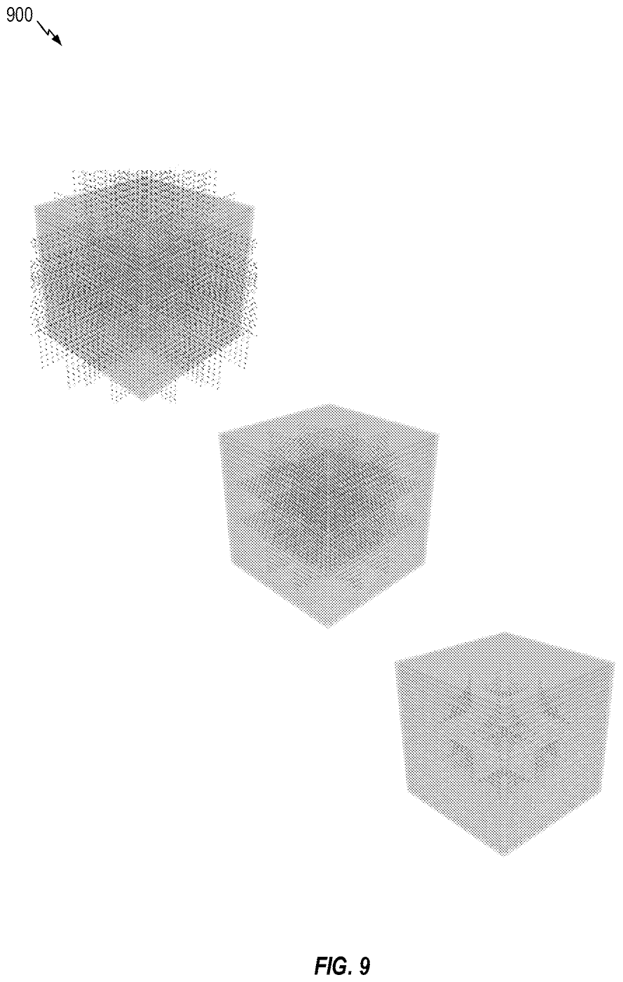

FIG. 9 illustrates example centers of the spheres defined for a cubical surface at different stages of the selection process. The center of all of the spheres that are initially generated are shown at the top. The spheres that remain after the processors remove any sphere whose center is not shared are shown in the middle. The spheres that define more than one connected interface within are shown on the bottom.

At this point, the intersection of each sphere in Ψ with the boundary of Ω may be guaranteed to occur at the contact angle θ at least one point, the center of the voxel face used to define the contact angle. Consequently, there exist many elements of Ψ that may not generate candidate fluid interfaces that are physically valid. To make sure that the spheres in Ψ generate interfaces that correctly intersect with the boundary of Ω at more than one point, one or more processors may remove any spheres that are not within a distance, ϵ, of their closest neighbor. This step in the procedure may be optional, since the one or more processors further impose this contact angle constraint in a later step. However, by removing these spheres in this step the one or more processors avoid generating several unrealistic interfaces and may greatly reduce the computational cost of working with unrealistic interfaces at later stages of the analysis.

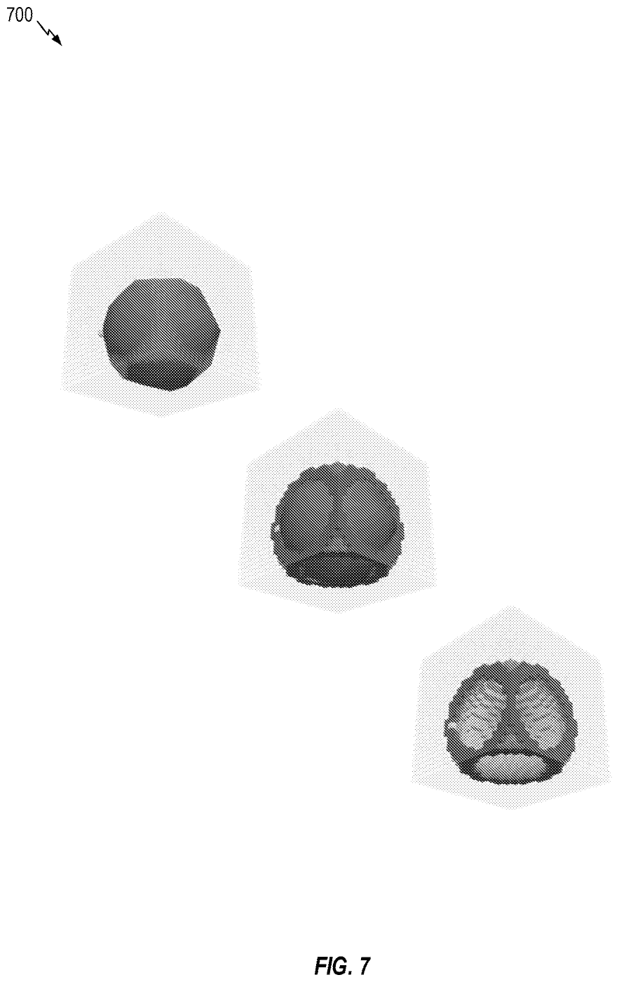

In the next step of the procedure, the one or more processors may construct a coarse scale discretization of each spheres surface. For s∈Ψ and voxel v∈Ω, let dᵥₛ be the distance from the center of v to the center of s. The processors may then define the discretized surface of the sphere as the set of voxels of v∈Ω, such that 2|dᵥₛ−r|<√3h. In this way, any voxel whose circumscribing sphere overlaps with the surface of s is used to represent the discretized surface. Consequently, this discretization may represent an over-estimate of the voxels that the surface passes through. At this stage of the procedure, the construction of a finer discretization of each spherical surface would be computationally expensive. Thus, before refining the discretization any further, the one or more processors use this coarse representation to efficiently remove nonphysical interfaces before refining the surface. By over sampling the voxels in this coarse discretization, the processors may allow for the construction of an accurate fine scale discretization of fluid interfaces during later steps of the procedure. An example of a sphere and its corresponding discretized surface in Ω is given in FIG. 7. An example sphere and the voxel of Γ used to define the sphere are shown on the top. The discretized surface and its defining sphere are shown together in the middle. The discretized surface of the sphere is shown by itself one the bottom.

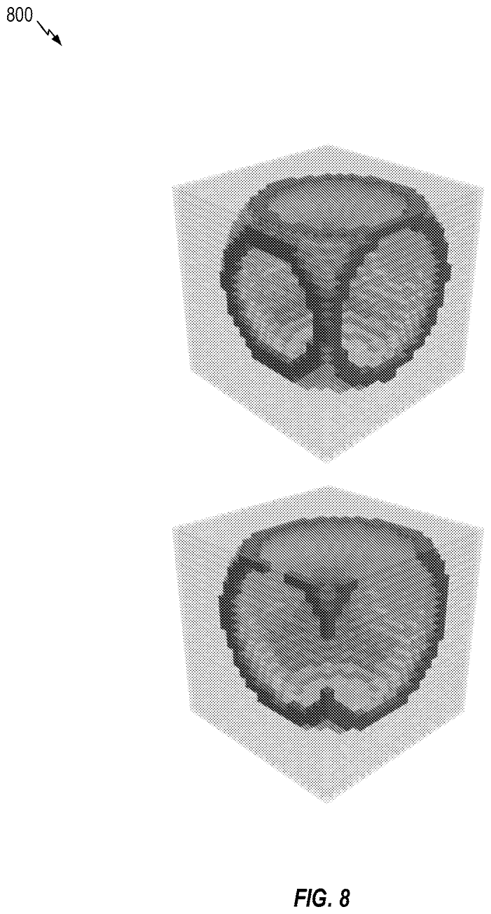

For a voxel face γᵢ ∈Γ, the one or more processors may define γᵢ to be the voxel of Ω that contains γᵢ. For a sphere s_{i,k} ∈ Ψ, defined using γᵢ, a corresponding discrete interface may be defined as the connected set of voxels of the discretized surface of s_{i,k} that contains vᵢ. It is possible for the boundary of Ω to break the surface of s_{i,k} into multiple disconnected subsets. However, by construction, the surface of s_{i,k} may only intersect with F with the desired contact angle at the center of γᵢ. Thus, any part of the sphere's surface that is not connected to this element is considered to be superfluous and is disregarded. The distinct interfaces defined in this way, using the spheres of Ψ, are considered as possible candidates for the final fluid configuration within the pore space. An example of the interfaces formed by the spheres of Ψ is illustrated in FIG. 8. The single interface defined by the top sphere a does not define a viable candidate interface. The two distinct interfaces defined by the bottom sphere are accepted and filtered through the proposed selection criteria. Candidate interfaces extracted from Ψ may be defined as A.

A set of physical and geometric criteria may be applied to each element of A by one or more processors in order to identify and remove nonphysical interfaces from the set. Of all of the candidate interfaces, Λ, only those that meet all applied selection criteria are used as valid interfaces for subsequent thermodynamic analysis.

Each network element represents a subsection of a original CT-image of the pore space, and is embedded inside the extracted pore network. Consequently, during flow modelling, the one or more processors seek to maintain consistency between the fluid configurations of neighboring regions of interest. Additionally, the processors apply estimations of fluid configurations within a network element to be as independent of the state of its neighbors as possible. To this end, the processors remove any elements of Λ that overlap with the voxels of that are shared with its neighboring regions of interest. In this way, the processors may avoid the construction of interfaces that partially fill the connections between neighboring regions of interest.

For a network element Ω, the one or more processors let Φ represent the subset of voxels of Ω that are also elements of its neighboring regions of interest. In this criterion, each λ∈Λ is checked to see if it shares any elements with Φ. If it is the case that λ∩Φ≠Ø, then λ is removed from Λ.

If an interface is an element of Ω, there is no guarantee that its points of intersection with Γ occur at the correct contact angle. By construction, each interface is only guaranteed to intersect with Γ with the correct contact angle at the center of the voxel face used to define it. Since the contact angle is only imposed loosely in the construction step, each interface of Λ may be checked to see if its intersections with Γ occur at sufficiently accurate contact angles.

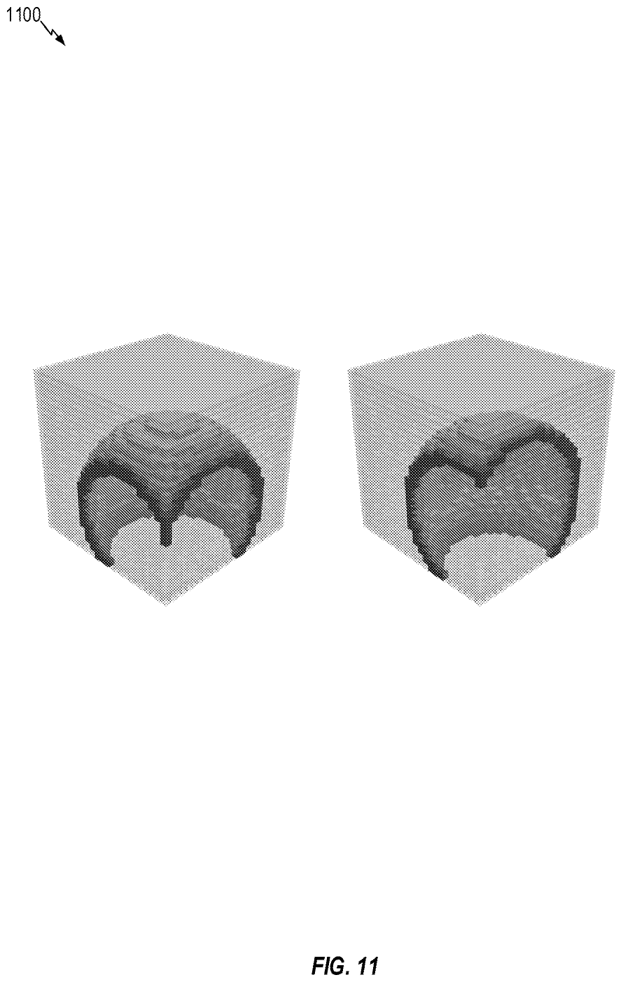

FIG. 11 illustrates example interfaces that intersect with Γ, each interface having a different contact angle. The interface on the left intersects with the voxels of Γ at a sufficiently accurate contact angle. The interface on the right is removed from Λ because its intersection with the voxels of Γ occur at inaccurate contact angles.

According to certain aspects, the one or more processors take steps to analyze the contact angles of a given element λ of Λ. First, the voxels of the discretized interface λ are checked to see if any of their faces are elements of Γ. If it is found that a face γₖ ∈Γ is part of a voxel of λ, the processors check if it is intersected by the sphere that defines λ. This is accomplished by checking if the distance from the four corners of γₖ and the center of the defining sphere of λ are greater than or less than r. If the distance between the sphere center and all four corners are not unanimously larger than or smaller than r then the interface is guaranteed to intersect γₖ. Since it is assumed that the resolution of the CT-Image sufficiently resolves the pore space, the processors may note that r may be larger than h and a check using only the corners of γₖ.

If the interface λ is determined to intersect with the voxel face γₖ, the quality of this contact angle is estimated. Rather than directly computing the contact angle, a computationally expensive process, the one or more processors may infer its quality using the distance from the spheres center to the plane that γₖ sits in (e.g., in the direction of nₖ). Specifically, the absolute difference, d_{λ,γk}, between the center of the defining sphere of λ and the center of γₖ in the direction of Ilk is computed. If |d_{λ,γk}−r|<ε, where c is proportional to h, then the interface is assumed to intersect with γₖ with a sufficiently accurate contact angle. The value of c is user dependent, but should be chosen to reflect inaccuracies inherent in the coarse discretization used to define λ, and the availability of computational resources to refine the interfaces A in subsequent steps.

Each interface in A divides Ω into two different sub-regions, one that contains the wetting phase and one that contains the nonwetting phase. In a drainage model, the non-wetting phase invades the pore space with a positive pressure. To honor this physical property of the model, the one or more processors indicate that interfaces considered for thermodynamic analysis may respect the direction of flow. For each λ∈Λ, the processors check that the direction of flow is honored in the following way. First, the processors identify the sub-regions of Ω that the interface defines as wetting and non-wetting phases. This is accomplished by first identifying any voxels whose distance from c, the center of the sphere that defines λ, is greater than r. Then, the wetting phase V_{λ,w}, is defined to be the simply connected set of these voxels that contains the voxel whose face was used to define λ. The non-wetting phase V_{λ,nw} is then defined as the complement of V_{λ}; notationally the processors have V_{λ,nw}=Ω\V_{λ,w}. Next, the distance between c and each connection between Ω and its neighbors is calculated. The processors then associate λ with the connection that is the closest to c. Before a region is invaded, the state of its connections (occupied by wetting, or non-wetting phases) is known or acertainable. If the connection that λ is associated with is occupied by the wetting phase and is also part of the subregion V_{λ}, then the direction of flow is honored. However, if this connection is occupied by the non-wetting phase, then the interface is pushing the non-wetting phase against the direction of flow. A similar condition is applied for the other combinations of connection occupancy. If it is determined that an interface is positioned to impede the direction of flow, then λ is removed from Λ.

During this check, it is possible for V_{λ} to overlap with more than one connection. Nevertheless, the one or more processors only require that the direction of flow condition is met for the closest connection. By keeping interfaces that impede the flow at other connections, the processors may allow for the possibility of a neck meniscus to form as potential interfaces during thermodynamic analysis. During this step, each interface is checked to see if it intersects with another element of Λ. If two interfaces are found to intersect, the interface with the largest surface area is removed from Λ. The purpose of this criterion is to remove interfaces that do not represent the minimal interfacial energy, since only interfaces with minimum contact between the wetting and non-wetting phases are kept to minimize unnecessary redundancy.

In some cases, the discretization used to define λ may be too coarse to accurately determine if two interfaces intersect. That is, with the current discretization of λ, the processors are only able to check if two interfaces go through the same voxel, but not if they intersect. Thus, the first step in checking this criterion is to refine the representation of the interface λ. In the discussion that follows, let σ represent the sphere that was used to define λ. Depending on the computational resources that are available, the processors choose the resolution at which the processors want to represent the surface of σ. Using this resolution, the processors define an integer Nₛₚ, the number of nodes that will be used to define a fine scale discretization of the surface of σ. The surface of the sphere, α, is then discretized into a set of Nₛₚ nodes.

Outside of a few special cases (for example, the vertices of platonic solids) it is difficult to discretize the surface of a sphere into equidistant nodes. To let the choice of Nₛₚ be flexible, and the selection of nodes to be efficient and consistent, the one or more processors may apply a lattice to refine σ. This type of discretization is favorable because the area represented by each node is roughly the same. This quality plays a vital role in estimating the surface area of each interface during thermodynamic analysis.

A fine discretization of λ may be defined to be the set of nodes of the fine discretization of σ that lie inside the voxels of the coarse discretization of λ. Note that after the first two criteria have been evaluated, the size of Λ has been reduced enough to make this step computationally inexpensive. Moreover, in the discussion that follows one or more processors use λ to represent the fine scale discretization of λ.

After the selection criteria have been applied, the set A consists of interfaces that are geometrically and physically valid. The next step of the procedure is to find the combination of these interfaces that is the most thermodynamically favorable.

Provided that knowledge of the pore geometry and contact angle are known or ascertainable, as described above, the fluid configurations within the pore network may be determined by balancing the Helmholtz free energy of the system. For a system undergoing drainage the characteristic analysis describe herein may be used to find configurations that are thermodynamically favorable. In this approach, the change in free energy associated with infinitesimal fluid movements is minimized. For example, Let A represent the area of the interface between two fluids and Aₘₛ be the area between fluid phase m and the solid phase. Then the change in free energy of the system is given by the following equation:

dF=σdA+σ_{ws}dA_{ws}+σ_{nws}dA_{nws}+(P_{w}−P_{nw})dV (9)

Since the one or more processors may only considering the presence of two distinct fluid phases, if volume of one phase is increased, the volume of the other phase correspondingly decreases. Thus, dA_{ws}=−dA_{nws} and simplify (9) to state the following:

dF=σdA+σ_{ws}dA_{ws}+σn_{ws}dA_{nws}+(P_{w}−P_{nw})dV (10)
where we have used the definition of the capillary pressure P_{c}. The equation may be further reduced to:

dF=σ(dA+cos(θ)dA_{nws}−κdV). (11)

By imposing that the system be at thermodynamic equilibrium, dF=0, we conclude the following:

$$κ = \frac{d A + cos ( θ ) dAnws}{d V} \qquad ( 12 )$$

To find the combination of these interfaces that is the most thermodynamically favorable, the components of (12) are approximated for each combination of valid interfaces. In the discussion that follows, let Λₖ be a combination (e.g., subset) of interfaces in Λ.

To estimate the change in volume, ΔV, of Λₖ, the one or more processors first determine the voxels of Ω that would be occupied by the wetting phase, V_{w}. To begin the aggregation process, the processors select a λ∈Λₖ and set V_{w}=V_{λ}. To update V_{w}, the processors then select a new element λᵢ ∈Λₖ and check if V_{λi} and V_{w} share any elements. If V_{w} ∩V_{λi}=0, the processors set V_{w}=V_{w} ∪Vλi. Otherwise the processors set V_{w}=V_{w} ∩V_{λi}.

V_{λi} corresponds to λᵢ ∈Λₖ. The processors begin by setting ΔV=V_{λ}, where λ is the first element in Λₖ.

To estimate the value of ΔV, the one or more processors begin by identifying the voxels of Ω that are on each side of the interfaces considered. To accomplish this, the distance between the center of each voxel of Ω and the center of each sphere of Ψ is computed. If this distance is found to be larger than r, then the voxel is identified as part of the non-wetting subregion. If a flagged voxel is found to be connected to an interface under consideration, its volume is then added to the term V_{w}. Letting V_{T} represent the total volume of all the voxels of Ω, the change in volume of the nonwetting phase can be estimated as follows:

ΔV=V_{T}−V_{w} (13)

The total area of the surface of the network element may be estimated by assuming that each voxel of Γ represents a two dimensional square of the surface. The total area of the region, A_{w}, is then estimated by summing over the estimated area associated with each voxel of Γ. An approximation for the surface area between the wetting phase and the solid phase A_{w} is obtained by performing a similar estimate on the intersection between the voxels used to define V_{w} and Γ. The value of ΔA_{nws}, the surface area of the boundary of the pore space that is in contact with the non-wetting phase, may be approximated as follows:

ΔA_{nws}=Δ_{T}−A_{w} (14)

To estimate the total surface area of the interface between the wetting and nonwetting fluids, the one or more processors may generate an interface that is generated by a sphere with total surface area A=4πr². An estimate for the percentage of the total area of the sphere that each interface represents may be computed by counting the total number of voxels that define the discretized interface. By multiplying this percentage to the known area of the sphere, an estimate for ΔA may be obtained.

Since the one or more processors are interested in modeling drainage displacement within the porous media, it is reasonable to assume that the lowest value of all these estimates represents the most thermodynamically favorable configuration. Once the smallest value of the local threshold capillary pressure has been obtained, a new estimate for the value of r is determined and the iteration is repeated until convergence is reached.

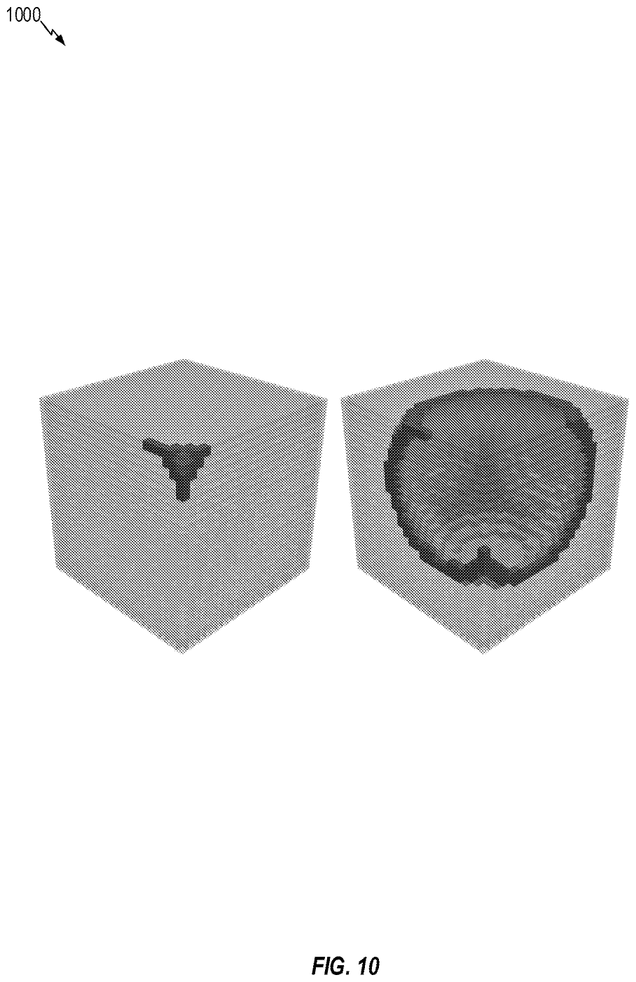

FIG. 10 illustrates example interfaces that are converging towards and diverging from the wetting region. On the left, an interface that is converging towards the wetting subregion is depicted. An example of an interface that is diverging away from the wetting region is provided on the right.

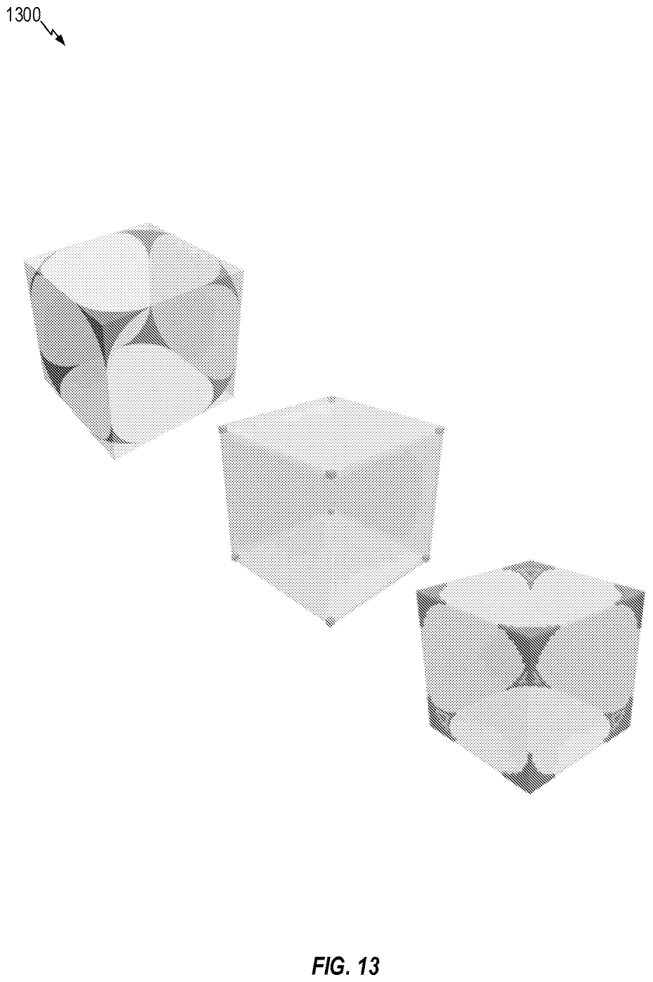

FIG. 12 and FIG. 13 depict portions of an example validation study performed according to aspects of the present disclosure. In this validation study, aspect of the present disclosure were applied to two voxel images of the cube with different resolutions. For both examples shown, the iteration was performed until the relative error between updated radius values was less than about 10⁻³. For a voxel image of the cube consisting of 25³ voxels with unit side lengths, a relative percent error of the estimated threshold capillary pressure was found to be about 3-5%. For a voxel image of the cube consisting of 50³ voxels with side lengths of half a unit, a percent error of the estimated threshold capillary pressure was found to be about 3-5%. Both of these results are promising, as the relative error is minimal and improves as the resolution of the image is refined.

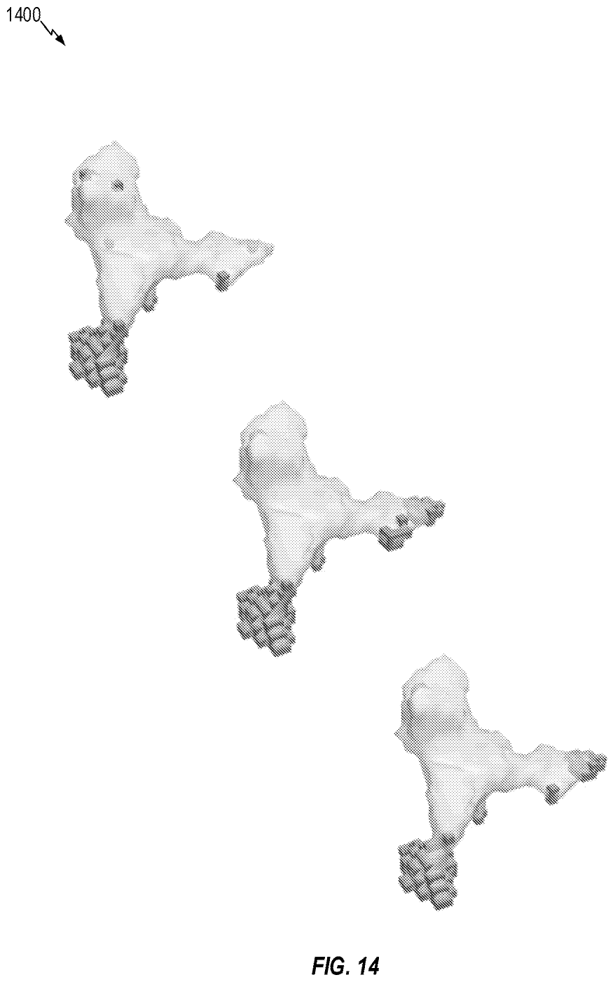

FIG. 14 illustrates an example real-pore geometry test applied output results of the procedure described herein. First, threshold capillary pressure estimates for the pore depicted in FIG. 5 were generated according to aspects of the present disclosure using a range of contact angles. Voxel images of the optimal fluid configurations corresponding to three different contact angles are shown in FIG. 14. The resulting optimal fluid configurations, generated via construction and refinement of pore body and pore throat elements within a space, represent fluid flow through porous media in a way substantially more accurate than fluid flow configurations generated according to previous models.

Thus, by implementing aspects described herein, pore network modeling may be enhanced to better characterize optimal fluid configurations within a pore network targeted for characterization, without having to rely on expensive computational procedures. As a result, users may be able to rely more comfortably on fluid flow characterization information generated according to procedures described above.

### Example Methods

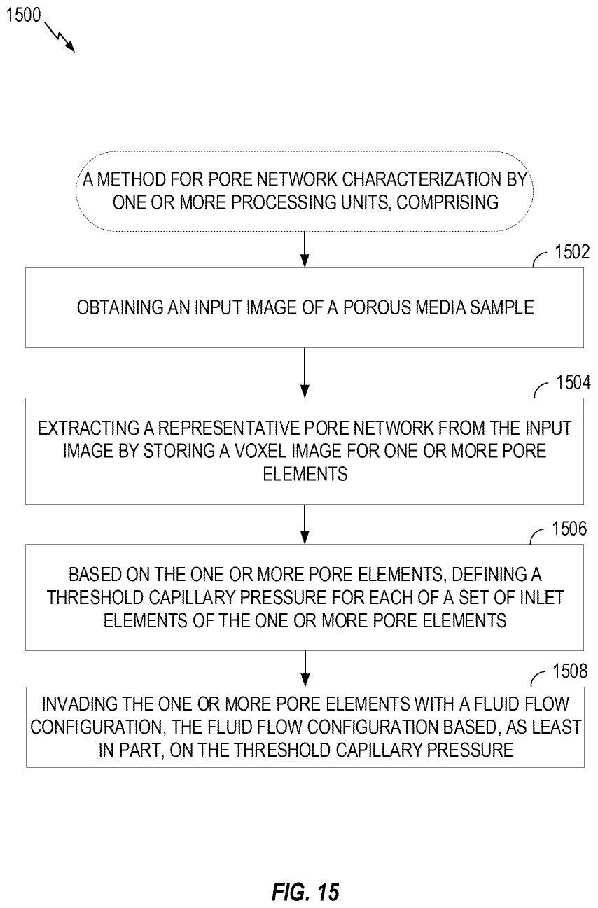

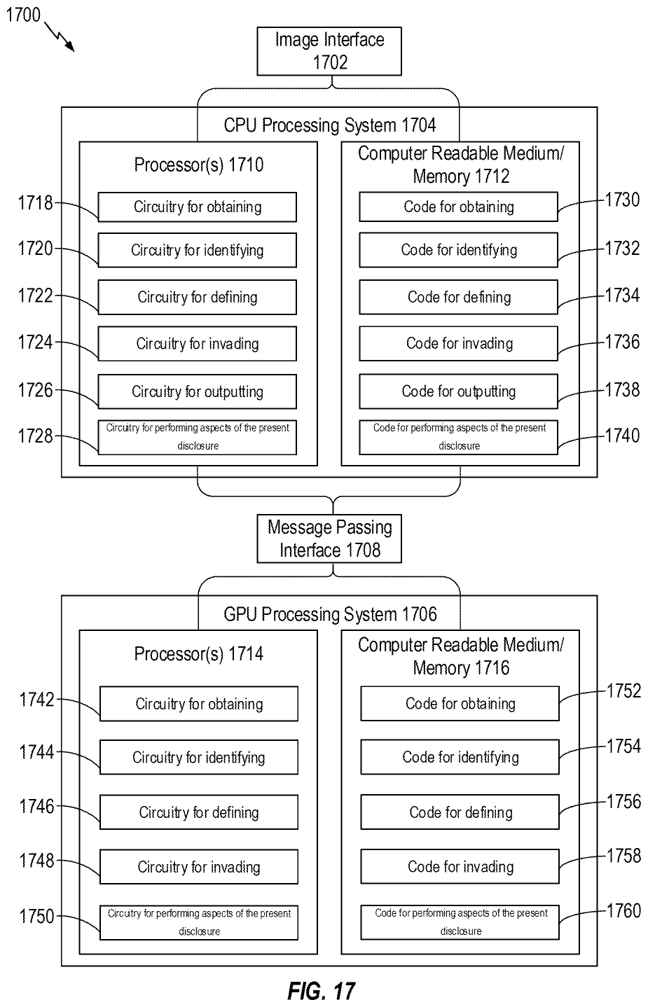

FIG. 15 depicts a method 1500 for pore network extraction by one or more processors, such as the CPUs and/or GPUs of the device 1700 of FIG. 17.

Method 1500 begins at 1502, when one or more processors may obtain an input image of a porous media sample. In some cases, the porous media sample is a rock sample.

At 1504, the one or more processors may extract a representative pore network from the input image by storing a voxel image for one or more pore elements.

At 1506, the one or more processors may, based on the one or more pore elements, define a threshold capillary pressure for each of a set of inlet elements of the one or more pore elements.

At 1508, the one or more processors may invade the one or more pore elements with a fluid flow configuration, the fluid flow configuration based, as least in part, on the threshold capillary pressure. In some cases, invading may include updating a fluid pressure to a minimum threshold capillary pressure value, and updating the fluid configuration for each of the one or more pore elements, the fluid configuration for each of the one or more pore elements capable of invading the one or more pore elements at the fluid pressure.

The one or more processors may further output a set of results based on the invasion, the set of results including at least one of the representative pore network, characteristics of the representative pore network, the fluid flow configuration, and characteristics of the fluid flow configuration

Note that FIG. 15 is just one example of a method, and other methods including fewer, additional, or alternative steps are possible consistent with this disclosure.

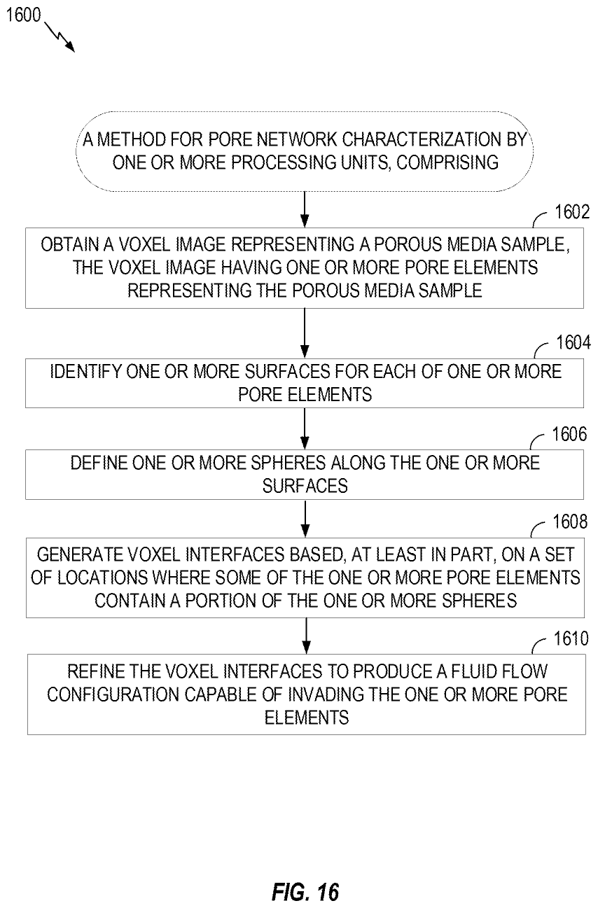

FIG. 16 depicts a method 1600 for pore network extraction by one or more processors, such as the CPUs and/or GPUs of the device 1700 of FIG. 17.

Method 1600 begins at 1602, when one or more processors may obtain a voxel image representing a porous media sample, the voxel image having one or more pore elements representing the porous media sample.

At 1604, the one or more processors may identify one or more surfaces for each of one or more pore elements.

At 1606, the one or more processors may define one or more spheres along the one or more surfaces.

At 1608, the one or more processors may generate voxel interfaces based, at least in part, on a set of locations where some of the one or more pore elements contain a portion of the one or more spheres.

At 1610, the one or more processors may refine the voxel interfaces to produce a fluid flow configuration capable of invading the one or more pore elements. In some cases, refining may include at least one of removing a first portion of the voxel interfaces, the first portion being shared between at least two of the one or more pore elements, removing a second portion of the voxel interfaces, the second portion intersecting with the one or more surfaces in a substantially invalid manner, removing a third portion of the voxel interfaces, the third portion being incompatible with the fluid configuration, and removing a fourth portion of the voxel interfaces, the forth portion of voxel interfaces intersecting with any of the voxel interfaces. In some cases, producing a fluid flow configuration capable of invading the one or more pore elements includes testing the voxel interfaces to generate a thermodynamically favorable configuration of the voxel interfaces, and constructing the fluid flow configuration based, at least in part, on the thermodynamically favorable configuration of the voxel interfaces.

The one or more processors may further output at least one of the voxel interfaces and the fluid configuration.

The one or more processors may further evaluate a fluid pressure value for the voxel image, and based on the evaluating, compute assigned values for one or more meniscus radii for the voxel image. In some cases, defining the one or more spheres is based, at least in part, on the assigned values and one or more contact angles.

The one or more processors may further remove a portion of the one or more spheres from the one or more surfaces based on positions of each of the one or more spheres. In some cases, the positions of each of the one or more spheres are substantially similar and capable of representing an invalid fluid configuration.

The one or more processors may further remove a portion of voxels from the voxel interfaces, the portion of the voxels disconnected from a defining voxel of the voxel interface.

Note that FIG. 16 is just one example of a method, and other methods including fewer, additional, or alternative steps are possible consistent with this disclosure.

### Example Devices

FIG. 17 depicts aspects of an example device 1700. In some aspect, the device 1700 comprises one or more CPUs, one or more GPUs, or both as described above.

The device 1700 includes a CPU processing system 1704 coupled to an image interface 1702 (e.g., a user interface or and/or an image generator such as a commercial micro-CT scanner). The CPU processing system 1704 may be configured to perform processing functions for the device 1700, including pore network extraction performed by the device 1700.

The CPU processing system 1704 includes one or more processors 1710. The one or more processors 1710 are coupled to a computer-readable medium/memory 1712 via a bus. The one or more processors 1710 and the computer-readable medium/memory 1712 may communicate with the one or more processor 1714 and the computer-readable medium/memory 1716 of the GPU processing system 1706 via a message passing interface (MPI) 1708. In certain aspects, the computer-readable medium/memory 1712 is configured to store instructions (e.g., computer-executable code) that when executed by the one or more processors 1710, cause the one or more processors 1710 to perform the method 1500 described with respect to FIG. 15, or any aspect related to it. Note that reference to a processor performing a function of device 1700 may include one or more processors performing that function of device 1700.

In the depicted example, computer-readable medium/memory 1712 stores code (e.g., executable instructions) 1730-1740 for performing techniques described herein, according to aspects of the present disclosure. Processing of the code 1730-1740 may cause the device 1700 to perform the method 1500 described with respect to FIG. 15, or any aspect related to it, including obtaining, extracting, defining, invading, outputting, updating, and any other suitable performance.

The one or more processors 1710 include circuitry configured to implement (e.g., execute) the code stored in the computer-readable medium/memory 1712, including circuitry 1718-1728 for performing techniques described herein, according to aspects of the present disclosure. Processing with circuitry 1718-1728 may cause the device 1700 to perform the method 1500 described with respect to FIG. 15, or any aspect related to it, including obtaining, extracting, defining, invading, outputting, updating, and any other suitable performance.

Various components of the device 1700 may provide means for performing the method 1500 described with respect to FIG. 15, or any aspect related to it.

The device 1700 includes a GPU processing system 1706. The GPU processing system 1706 may be configured to perform processing functions for the device 1700, pore network extraction performed by the device 1700.

The GPU processing system 1706 includes one or more processors 1714. The one or more processors 1714 are coupled to a computer-readable medium/memory 1716 via a bus. The one or more processors 1714 and the computer-readable medium/memory 1716 may communicate with the one or more processor 1710 and the computer-readable medium/memory 1712 of the CPU processing system 1704 via an MPI 1708. In certain aspects, the computer-readable medium/memory 1716 is configured to store instructions (e.g., computer-executable code) that when executed by the one or more processors 1714, cause the one or more processors 1714 to perform the method 1500 described with respect to FIG. 15, or any aspect related to it. Note that reference to a processor performing a function of device 1700 may include one or more processors performing that function of device 1700.

In the depicted example, computer-readable medium/memory 1716 stores code (e.g., executable instructions) for performing certain functions according to aspects of the present disclosure 1752-1760. Processing of the code 1752-1760 may cause the device 1700 to perform the method 1500 described with respect to FIG. 15, or any aspect related to it, including obtaining, extracting, defining, invading, outputting, updating, and any other suitable performance.

The one or more processors 1714 include circuitry configured to implement (e.g., execute) the code stored in the computer-readable medium/memory 1716, including circuitry for performing certain functions according to aspects of the present disclosure 1742-1750. Processing with circuitry 1742-1750 may cause the device 1700 to perform the method 1500 described with respect to FIG. 15, or any aspect related to it, including obtaining, extracting, defining, invading, outputting, updating, and any other suitable performance.

Various components of the device 1700 may provide means for performing the method 1500 described with respect to FIG. 15, or any aspect related to it.

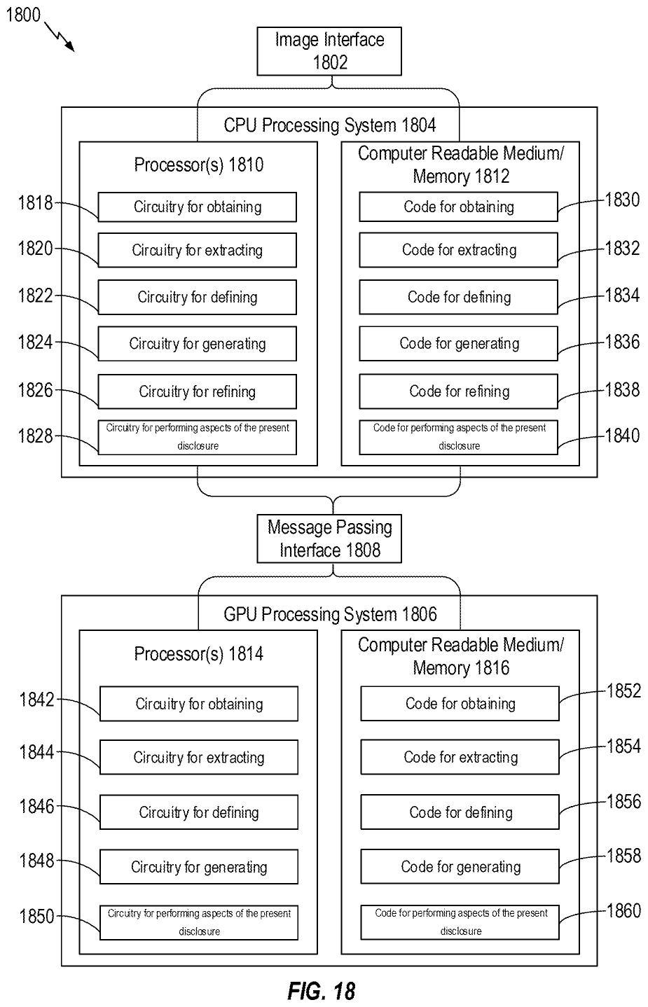

FIG. 18 depicts aspects of an example device 1800. In some aspect, the device 1800 comprises one or more CPUs, one or more GPUs, or both as described above.

The device 1800 includes a CPU processing system 1804 coupled to an image interface 1802 (e.g., a user interface or and/or an image generator such as a commercial micro-CT scanner). The CPU processing system 1804 may be configured to perform processing functions for the device 1800, including pore network extraction performed by the device 1800.

The CPU processing system 1804 includes one or more processors 1810. The one or more processors 1810 are coupled to a computer-readable medium/memory 1812 via a bus. The one or more processors 1810 and the computer-readable medium/memory 1812 may communicate with the one or more processor 1814 and the computer-readable medium/memory 1816 of the GPU processing system 1806 via a message passing interface (MPI) 1808. In certain aspects, the computer-readable medium/memory 1812 is configured to store instructions (e.g., computer-executable code) that when executed by the one or more processors 1810, cause the one or more processors 1810 to perform the method 1600 described with respect to FIG. 16, or any aspect related to it. Note that reference to a processor performing a function of device 1800 may include one or more processors performing that function of device 1800.

In the depicted example, computer-readable medium/memory 1812 stores code (e.g., executable instructions) 1830-1840 for performing techniques described herein, according to aspects of the present disclosure. Processing of the code 1830-1840 may cause the device 1800 to perform the method 1600 described with respect to FIG. 16, or any aspect related to it, including obtaining, identifying, defining, generating, refining, outputting, computing, removing, testing, constructing, producing, and any other suitable performance.

The one or more processors 1810 include circuitry configured to implement (e.g., execute) the code stored in the computer-readable medium/memory 1812, including circuitry 1818-1828 for performing techniques described herein, according to aspects of the present disclosure. Processing with circuitry 1818-1828 may cause the device 1800 to perform the method 1600 described with respect to FIG. 16, or any aspect related to it, including obtaining, identifying, defining, generating, refining, outputting, computing, removing, testing, constructing, producing, and any other suitable performance.

Various components of the device 1800 may provide means for performing the method 1600 described with respect to FIG. 16, or any aspect related to it.

The device 1800 includes a GPU processing system 1806. The GPU processing system 1806 may be configured to perform processing functions for the device 1800, pore network extraction performed by the device 1800.

The GPU processing system 1806 includes one or more processors 1814. The one or more processors 1814 are coupled to a computer-readable medium/memory 1816 via a bus. The one or more processors 1814 and the computer-readable medium/memory 1816 may communicate with the one or more processor 1810 and the computer-readable medium/memory 1812 of the CPU processing system 1804 via an MPI 1808. In certain aspects, the computer-readable medium/memory 1816 is configured to store instructions (e.g., computer-executable code) that when executed by the one or more processors 1814, cause the one or more processors 1814 to perform the method 1600 described with respect to FIG. 16, or any aspect related to it. Note that reference to a processor performing a function of device 1800 may include one or more processors performing that function of device 1800.

In the depicted example, computer-readable medium/memory 1816 stores code (e.g., executable instructions) for performing certain functions according to aspects of the present disclosure 1852-1860. Processing of the code 1852-1860 may cause the device 1800 to perform the method 1600 described with respect to FIG. 16, or any aspect related to it, including obtaining, identifying, defining, generating, refining, outputting, computing, removing, testing, constructing, producing, and any other suitable performance.

The one or more processors 1814 include circuitry configured to implement (e.g., execute) the code stored in the computer-readable medium/memory 1816, including circuitry for performing certain functions according to aspects of the present disclosure 1842-1850. Processing with circuitry 1842-1850 may cause the device 1800 to perform the method 1600 described with respect to FIG. 16, or any aspect related to it, including obtaining, identifying, defining, generating, refining, outputting, computing, removing, testing, constructing, producing, and any other suitable performance.

Various components of the device 1800 may provide means for performing the method 1600 described with respect to FIG. 16, or any aspect related to it.

### Example Aspects

Implementation examples are described in the following numbered clauses:

Aspect 1: A method for pore network characterization by one or more processing units, comprising: obtaining an input image of a porous media sample; extracting a representative pore network from the input image by storing a voxel image for one or more pore elements; based on the one or more pore elements, defining a threshold capillary pressure for each of a set of inlet elements of the one or more pore elements; and invading the one or more pore elements with a fluid flow configuration, the fluid flow configuration based, as least in part, on the threshold capillary pressure.

Aspect 2: The method of aspect 1, further comprising outputting a set of results based on the invasion, the set of results including at least one of the representative pore network, characteristics of the representative pore network, the fluid flow configuration, and characteristics of the fluid flow configuration.

Aspect 3: The method of any one of aspects 1 and 2, wherein invading the one or more pore elements with the fluid flow configuration further comprises: updating a fluid pressure to a minimum threshold capillary pressure value; and updating the fluid configuration for each of the one or more pore elements, the fluid configuration for each of the one or more pore elements capable of invading the one or more pore elements at the fluid pressure.

Aspect 4: The method of any one of aspects 1 through 3, wherein the porous media sample is a rock sample.

Aspect 5: A method for pore network characterization by one or more processing units, comprising: obtaining a voxel image representing a porous media sample, the voxel image having one or more pore elements representing the porous media sample; identifying one or more surfaces for each of one or more pore elements; defining one or more spheres along the one or more surfaces; generating voxel interfaces based, at least in part, on a set of locations where some of the one or more pore elements contain a portion of the one or more spheres; and refining the voxel interfaces to produce a fluid flow configuration capable of invading the one or more pore elements.

Aspect 6: The method of aspect 5, further comprising outputting at least one of the voxel interfaces and the fluid configuration.

Aspect 7: The method of any one of aspects 5 and 6, further comprising: evaluating a fluid pressure value for the voxel image; and based on the evaluating, computing assigned values for one or more meniscus radii for the voxel image.

Aspect 8: The method of aspect 7, wherein defining the one or more spheres comprises: defining the one or more spheres based, at least in part, on the assigned values and one or more contact angles.

Aspect 9: The method of any one of aspects 5 through 8, further comprising removing a portion of the one or more sphere from the one or more surfaces based on positions of each of the one or more spheres.

Aspect 10: The method of aspect 9, wherein the positions of each of the one or more spheres are substantially similar and capable of representing an invalid fluid configuration.

Aspect 11: The method of any one of aspects 5 through 10, further comprises removing a portion of voxels from the voxel interfaces, the portion of the voxels disconnected from a defining voxel of the voxel interface.

Aspect 12: The method of any one of aspects 5 through 11, wherein refining the voxel interfaces comprises at least one of: removing a first portion of the voxel interfaces, the first portion being shared between at least two of the one or more pore elements; removing a second portion of the voxel interfaces, the second portion intersecting with the one or more surfaces in a substantially invalid manner; removing a third portion of the voxel interfaces, the third portion being incompatible with the fluid configuration; and removing a fourth portion of the voxel interfaces, the forth portion of voxel interfaces intersecting with any of the voxel interfaces.

Aspect 13: The method of any one of aspects 5 through 12, wherein producing a fluid flow configuration capable of invading the one or more pore elements comprises: testing the voxel interfaces to generate a thermodynamically favorable configuration of the voxel interfaces; and constructing the fluid flow configuration based, at least in part, on the thermodynamically favorable configuration of the voxel interfaces.

Aspect 14: The method of any one of aspects 5 through 13, wherein the porous media sample is a rock sample.

Aspect 15: An apparatus, comprising: a memory comprising executable instructions; and a processor configured to execute the executable instructions and cause the apparatus to perform a method in accordance with any one of Aspects 1-14.

Aspect 16: An apparatus, comprising means for performing a method in accordance with any one of Aspects 1-14.

Aspect 17: A non-transitory computer-readable medium comprising executable instructions that, when executed by a processor of an apparatus, cause the apparatus to perform a method in accordance with any one of Aspects 1-14.

Aspect 18: A computer program product embodied on a computer-readable storage medium comprising code for performing a method in accordance with any one of Aspects 1-14.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

As used herein, the term “determining” encompasses a wide variety of actions. For example, “determining” may include calculating, computing, processing, deriving, investigating, updating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, simulating, choosing, establishing, and the like.

The methods disclosed herein comprise one or more operations or actions for achieving the methods. The method operations and/or actions may be interchanged with one another without departing from the scope of the claims. In other words, unless a specific order of operations or actions is specified, the order and/or use of specific operations and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the figures, those operations may have corresponding counterpart means-plus-function components with similar numbering.

When the word “approximately” or “about” are used, this term may mean that there may be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is envisioned under the scope of the various embodiments described.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Unless defined otherwise, all technical and scientific terms used have the same meaning as commonly understood by one of ordinary skill in the art to which these systems, apparatuses, methods, processes and compositions belong.

The following claims are not intended to be limited to the embodiments provided but rather are to be accorded the full scope consistent with the language of the claims.

What is claimed is:

1. A method for pore network characterization by one or more processing units, comprising:
obtaining an input image of a porous media sample;
extracting a representative pore network from the input image by storing a voxel image for one or more pore elements;
based on the one or more pore elements, defining a threshold capillary pressure for each of a set of inlet elements of the one or more pore elements; and
invading the one or more pore elements with a fluid flow configuration, the fluid flow configuration based, as least in part, on the threshold capillary pressure.

2. The method of claim 1, further comprising outputting a set of results based on the invasion, the set of results including at least one of the representative pore network, characteristics of the representative pore network, the fluid flow configuration, and characteristics of the fluid flow configuration.

3. The method of claim 1, wherein invading the one or more pore elements with the fluid flow configuration further comprises:
updating a fluid pressure to a minimum threshold capillary pressure value; and
updating the fluid configuration for each of the one or more pore elements, the fluid configuration for each of the one or more pore elements capable of invading the one or more pore elements at the fluid pressure.

4. The method of claim 1, wherein the porous media sample is a rock sample.

5. A method for pore network characterization by one or more processing units, comprising:
obtaining a voxel image representing a porous media sample, the voxel image having one or more pore elements representing the porous media sample;
identifying one or more surfaces for each of one or more pore elements;
defining one or more spheres along the one or more surfaces;
generating voxel interfaces based, at least in part, on a set of locations where some of the one or more pore elements contain a portion of the one or more spheres; and
refining the voxel interfaces to produce a fluid flow configuration capable of invading the one or more pore elements.

6. The method of claim 5, further comprising outputting at least one of the voxel interfaces and the fluid configuration.

7. The method of claim 5, further comprising:
evaluating a fluid pressure value for the voxel image; and
based on the evaluating, computing assigned values for one or more meniscus radii for the voxel image.

8. The method of claim 7, wherein defining the one or more spheres comprises:
defining the one or more spheres based, at least in part, on the assigned values and one or more contact angles.

9. The method of claim 5, further comprising removing a portion of the one or more sphere from the one or more surfaces based on positions of each of the one or more spheres.

10. The method of claim 9, wherein the positions of each of the one or more spheres are substantially similar and capable of representing an invalid fluid configuration.

11. The method of claim 5, further comprises removing a portion of voxels from the voxel interfaces, the portion of the voxels disconnected from a defining voxel of the voxel interface.

12. The method of claim 5, wherein refining the voxel interfaces comprises at least one of:
removing a first portion of the voxel interfaces, the first portion being shared between at least two of the one or more pore elements;
removing a second portion of the voxel interfaces, the second portion intersecting with the one or more surfaces in a substantially invalid manner;
removing a third portion of the voxel interfaces, the third portion being incompatible with the fluid configuration; and
removing a fourth portion of the voxel interfaces, the forth portion of voxel interfaces intersecting with any of the voxel interfaces.

13. The method of claim 5, wherein producing a fluid flow configuration capable of invading the one or more pore elements comprises:
testing the voxel interfaces to generate a thermodynamically favorable configuration of the voxel interfaces; and
constructing the fluid flow configuration based, at least in part, on the thermodynamically favorable configuration of the voxel interfaces.

14. The method of claim 5, wherein the porous media sample is a rock sample.

15. An apparatus, comprising: a memory comprising executable instructions, and one or more processors configured to execute the executable instructions and cause the apparatus to:
obtain an input image of a porous media sample;
extract a representative pore network from the input image by storing a voxel image for one or more pore elements;
based on the one or more pore elements, define a threshold capillary pressure for each of a set of inlet elements of the one or more pore elements; and
invade the one or more pore elements with a fluid flow configuration, the fluid flow configuration based, as least in part, on the threshold capillary pressure.

16. The apparatus of claim 1, wherein the one or more processors are further configured to output a set of results based on the invasion, the set of results including at least one of the representative pore network, characteristics of the representative pore network, the fluid flow configuration, and characteristics of the fluid flow configuration.

17. The apparatus of claim 1, wherein invading the one or more pore elements with the fluid flow configuration further comprises:
updating a fluid pressure to a minimum threshold capillary pressure value; and
updating the fluid configuration for each of the one or more pore elements, the fluid configuration for each of the one or more pore elements capable of invading the one or more pore elements at the fluid pressure.

18. The apparatus of claim 1, wherein the porous media sample is a rock sample.

19. An apparatus, comprising: a memory comprising executable instructions, and one or more processors configured to execute the executable instructions and cause the apparatus to:
obtain a voxel image representing a porous media sample, the voxel image having one or more pore elements representing the porous media sample;
identify one or more surfaces for each of one or more pore elements;
define one or more spheres along the one or more surfaces;
generate voxel interfaces based, at least in part, on a set of locations where some of the one or more pore elements contain a portion of the one or more spheres; and
refine the voxel interfaces to produce a fluid flow configuration capable of invading the one or more pore elements.

20. The apparatus of claim 19, further comprising outputting at least one of the voxel interfaces and the fluid configuration.
